(19) United States
(12) Patent Application Publication
(10) Pub. No.: US 2007/0063080 A1
(43) Pub. Date: Mar. 22, 2007

(54) Adjustable screen for loose fill fibrous insulation machine

(76) Inventors: Michael E. Evans, Granville, OH (US); Anthony T. Geise, Findlay, OH (US); Richard W. Bowen, Tonganoxie, KS (US)

Correspondence Address: OWENS CORNING, 2790 COLUMBUS ROAD, GRANVILLE, OH, 43023, US

(21) Appl. No.: 11/232,152

(22) Filed: Sep. 21, 2005

(51) Int. Cl. B02C 19/00

(52) U.S. Cl. 241/73

(57) ABSTRACT

A rotary mill is configured to cut fibrous insulation material into tufts of loosefil insulation. A housing of the mill has a rotary cutter assembly mounted therein having a plurality of radially outwardly extending vanes extending to the housing and being configured to sweep along the housing in a machine direction. A screen having a plurality of screen openings is positioned in the housing, each screen opening having an effective opening size. The screen comprises an inner plate having a plurality of inner openings formed therethrough and an outer plate having a plurality of outer openings formed therethrough. The inner openings correspond with the outer openings to define the screen openings, and the screen openings have an effective cutting edge oriented transversely to the machine direction. The inner and outer plates are mounted for movement relative to each other so the effective opening size of the screen openings can be changed. The length of the effective cutting edges of the screen openings are kept substantially constant regardless of any change in the size of the screen openings.

### TECHNICAL FIELD

This invention relates in general to fibrous insulation and, more particularly, to an apparatus for producing loose fill fibrous insulation suitable for blowing.

### BACKGROUND OF THE INVENTION

Loose fill insulation is generally known in the art to include loose fibrous material that is suitable for being blown into insulation cavities within a structure such as a home, commercial building, etc. Fibrous mats of insulation, also known as batts, are used to insulate structures. However, batts are typically formed in sizes that can be installed between studded walls, ceiling joists, etc. Both are formed from fiberglass that is formed using known methods.

Loose fill insulation is typically comprised of tufts or clumps of fibrous insulation and is packed in bags. Loose fill insulation is typically installed by being introduced into a hopper of a blower that can blow the insulation fibers into the designated area.

As will be described below, mineral fibers of the type used in both batt and loose fill insulation are formed from molten material using fiberizers. In the typical manufacturing process, molten mineral material is introduced into a plurality of fiberizers from a melt furnace. The fiberizers centrifuge the molten material into fibers that are then directed as a veil to other apparatuses for either forming a batt or to produce loose fill fibers.

Various methods of forming loose fill insulation have been developed. For example, hammermills have been used to cut fibrous insulation material to create the loose fill insulation. In general, a hammermill comprises a series of rotating hammers or cutting arms provided in a housing for breaking up masses of fibrous insulation. The hammermill then forces the fibrous insulation material through a plate having a plurality of orifices. One example of a conventional hammermill is disclosed in U.S. Pat. No. 3,584,796.

The reason for processing insulation by the mechanisms described above is to achieve certain insulative characteristics in the insulation. Various factors are known in the art to express the insulation value of a material or of a composite structure. Examples of these factors are a U, C, R, and K factor. The K factor, as it relates to insulation, is the rate at which heat flows through a material. Values for insulation are normally based on a material having a one-inch thickness. The units of measurement of the K factors are typically expressed in BTU/ft²/hour/inch. The lower the K factor, the more insulative effect the material has. For example, Vermiculite has a K factor of about 0.50-0.60. Fiberglass has a K factor between about 0.22-0.30. Urethane rigid foam has a typical K factor of about 0.11-0.16. The K factor of a material can change with age. Additionally, compacting the insulation material lowers the K factor.

The R factor of a material is a measure of the resistance of the material to heat flow. The R factor can be determined for a single material at a specific thickness. As the thickness of the material (e.g. insulation) increases, the resistance to heat flow increases. The R factor for a particular material can be determined in two ways. One way is to take the thickness of the material and divide it by the K factor. Alternatively, R factor equals one divided by the C factor. The higher the R factor, the better the insulative effect. For example, fiberglass has an R factor of 4 at one inch thick, 8 at two inches thick, and 12 at three inches thick.

The C factor is also a rate of heat transfer through a material, but is defined for any given thickness of the material, not just at one inch. The C factor at one inch thickness would be the same as the K factor. The U factor is the overall coefficient of heat transfer (conductivity) for all the elements of construction, as well as the environmental factors. For example, a U factor for a building wall board would include the interior gypsum wall board, the fiberglass insulation, the exterior wood sheathing, and the exterior siding or a masonry layer. The U factor would be determined by adding the C factors of the various individual materials making up the composite structure (i.e. U=C1+C2+C3). The units of measurement of the C factor are BTU/ft²/feet/hour. The smaller the U factor the better the insulative effect of the composite structure.

The various factors associated with a particular type of insulation depend on the manner in which the insulation is made and the way it is processed. Typical devices for forming loose fill insulation can form insulation of only one size, or only one density, from a single apparatus. Typically, in order to change the size of the insulation produced, or the densities (and the corresponding insulation factors), a difficult and time consuming adjustment to the apparatus is required.

### SUMMARY OF THE INVENTION

This invention relates to a rotary mill configured to cut fibrous insulation material into tufts. The rotary mill includes a housing having a rotary cutter assembly mounted therein. The rotary cutter assembly includes a plurality of radially outwardly extending vanes that extend to the housing and are configured to sweep along the housing in a machine direction. A screen is positioned in the housing and has a plurality of screen openings. Each screen opening has an effective opening size. The screen comprises an inner plate having a plurality of inner openings formed therethrough, and an outer plate having a plurality of outer openings formed therethrough. The inner openings correspond with the outer openings to define the screen openings, and the screen openings each have an effective cutting edge oriented transversely to the machine direction. The inner and outer plates are mounted for movement relative to each other such that the effective opening sizes of the screen openings in the screen can be changed. The length of the effective cutting edges of the screen openings are kept substantially constant regardless of any change in the size of the screen openings.

According to this invention there is also provided a method of forming tufts of loosefil insulation. The method includes providing a rotary cutter assembly having a housing, the rotary cutter assembly having a plurality of rotating vanes that extend to the housing and are configured to sweep along the housing in a machine direction. A screen is also provided within the rotary cutter assembly, the screen having an inner and outer plate, the inner plate having inner openings and the outer plate having outer openings corresponding to the inner openings. The inner and the outer openings define screen openings having an effective opening size, the screen openings having an effective cutting edge oriented transversely to the machine direction. The inner and outer plates are movable relative to each other to change the effective opening size of the screen openings. The method further includes introducing fibrous insulation material into the rotary cutter assembly and cutting the fibrous insulation material into tufts of loosefil insulation by rotating the cutter assembly to sweep the fibrous insulation material against the screen. The density of the tufts of loosefil insulation is modified while maintaining the tufts of loosefil insulation at a substantially constant size by moving the inner and outer plates relative to each other to change the effective opening size while maintaining the length of the effective cutting edges substantially constant.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a schematic elevation view of a loose fill insulation fabrication apparatus.

FIG. 2 is an enlarged elevation view of a rotary mill of the loose fill insulation fabrication apparatus.

FIG. 3 is an exploded perspective view of a screen of the rotary mill.

FIG. 4 is a perspective view of the screen of the rotary mill in a first configuration.

FIG. 5 is a perspective view of the screen of FIG. 4 with the screen in a second configuration.

FIG. 6 is an enlarged perspective view of a portion of the screen of the rotary mill shown in FIG. 5

FIG. 7 is an enlarged perspective view of a portion of an alternate embodiment of a screen of the rotary mill.

FIG. 8 is an enlarged perspective view of a portion of an alternate embodiment of a screen of the rotary mill.

### DETAILED DESCRIPTION OF THE INVENTION

Although specific terms are used in the following description for the sake of clarity, these terms are intended to refer generally to the structures of the invention selected for illustration in the Figures, and are not intended to define or limit the scope of the invention. In addition, although the invention will be described using glass fiber insulation as an example, it is to be understood that the insulation material can be any compressible fibrous material made of mineral fibers or polymeric fibers or both.

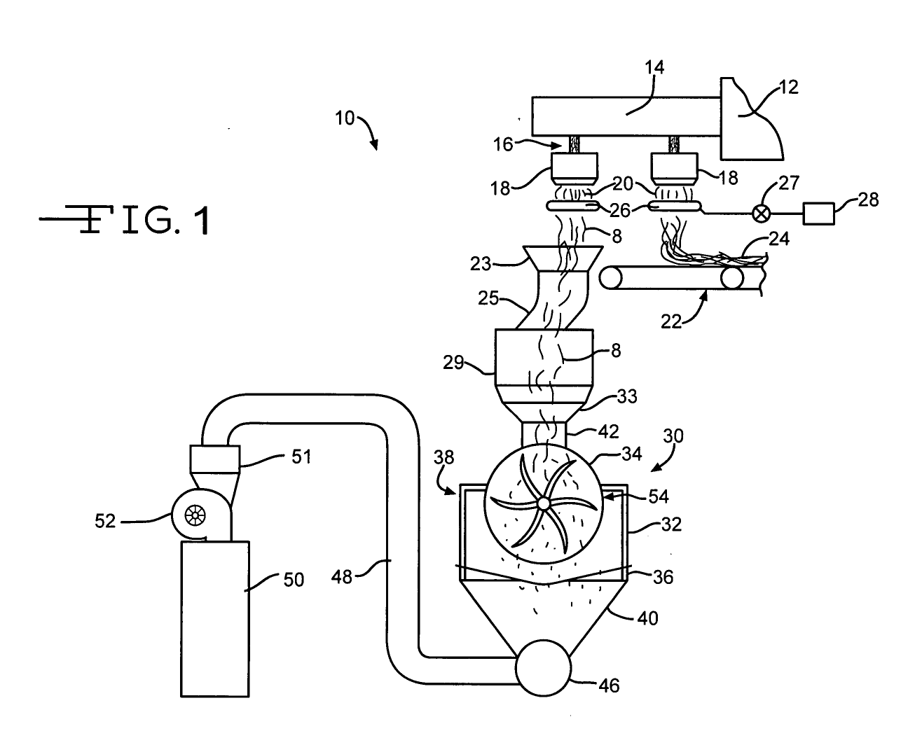

Referring now to the drawings, there is illustrated in FIG. 1 an apparatus, indicated generally at 10, for manufacturing loose fill insulation suitable for installation with any type of wool blowing equipment. As can be seen in FIG. 1, molten glass 16 is supplied from a forehearth 14 of a furnace 12 to rotary fiberizers 18 to form veils 20 of glass fibers 8 that are gathered as insulation material 68 and transported to further processing stations. For example, a conveyor 22 can transport some of the insulation material 68 to form glass blankets 24 or batts. As will be described below, some of the glass fibers 8 of the veil 20 are transported to an operating station or stations to form loose fill insulation. Although only two fiberizers 18 are shown, it should be appreciated that any number of fiberizers 18 may be used with the apparatus 10 to make loose fill insulation.

The fibers 8 can be coated with a lubricant after they are formed. In this embodiment, a series of nozzles 26 are positioned in a ring around the veil 20 at a position below the fiberizers 18. The nozzles 26 supply a lubricant (not shown) from a source 28 to the fibers 8. The application of the lubricant is controlled by a valve 27 so that the amount of lubricant being applied can be precisely controlled. In addition, since this portion of the apparatus 10 is being used to form loose fill insulation, a binder material is not applied to the fibers 8 in order to make a binderless product. It should be appreciated that the term “binderless” as used herein means that the binder materials applied to the fibers 8 are less than or equal to approximately one percent by weight of the product. However, it should be appreciated that any amount of binder could be applied to the fibers 8 as desired depending on the specific application and design requirements.

According to illustrated embodiment of the invention, some of the insulation material 68 is collected by a gathering member 23. It should be appreciated that the insulation material 68 could be collected on the conveyor 22 and then fed into a gathering member 23 that is located at a point further away from the fiberizers 18 if it is so desired. As shown, the gathering member 23 is shaped and sized to easily receive the insulation material 68. The gathering member 23 diverts the intercepted insulation material 68 to a duct 25 for transfer to one or more processing stations for further handling. The gathering member 23 and the duct 25 can be any generally hollow pipe members that are suitable for conveying the insulation material 68. As shown, the fiberizer 18 is associated with an individual gathering member 23 so that the insulation material 68 is received directly into the gathering member 23. Alternatively, a single gathering member 23 can be adapted to receive the insulation material 68 from multiple fiberizers 18 at once (not shown). Although the loose fill manufacturing apparatus 10 is shown with a gathering member 23, it is to be understood that the gathering member is optional, and the insulation material 68 can be directed from the fiberizers 18 or from the conveyor directly into the processing station 29 and rotary mill 30.

The gathering member 23 can also be adapted to receive both the insulation material 68 as well as an air flow. The air flow can be created by an optional blowing mechanism to direct the insulation material 68 in a given direction, usually in a downward manner. In the illustrated embodiment, the air flow is generated by the outlet of the fiberizers 18. The momentum of the air flow will cause the insulation material 68 to continue to move through the gathering member 23 and to the first processing station 29 and a rotary mill 30. Alternatively, or additionally, there can be another blowing mechanism, not shown, that blows or forces insulation material 68 toward the first processing station 29, or suction mechanism, not shown, that draws the insulation material 68 towards the first processing station. In the alternate embodiment wherein the gathering member 23 is positioned at the end of the conveyor 22, the blowing mechanism could be located above the gathering member 23 to direct the flow of the insulation material 68.

Prior to being received in the rotary mill 30, the operation of which will be described below, the insulation material 68 can be processed through one or more stations. For example, an optional first processing station 29 can be a rotary separator wherein the insulation material 68 is separated from the air that is blowing with the insulation material 68 into the gathering member 23. Rotary separators can also be used to form the insulation material 68 into smaller batches of material that can be processed more easily by subsequent processing stations. It should be appreciated that any desired processing can occur prior to the insulation material 68 being received in the rotary mill 30.

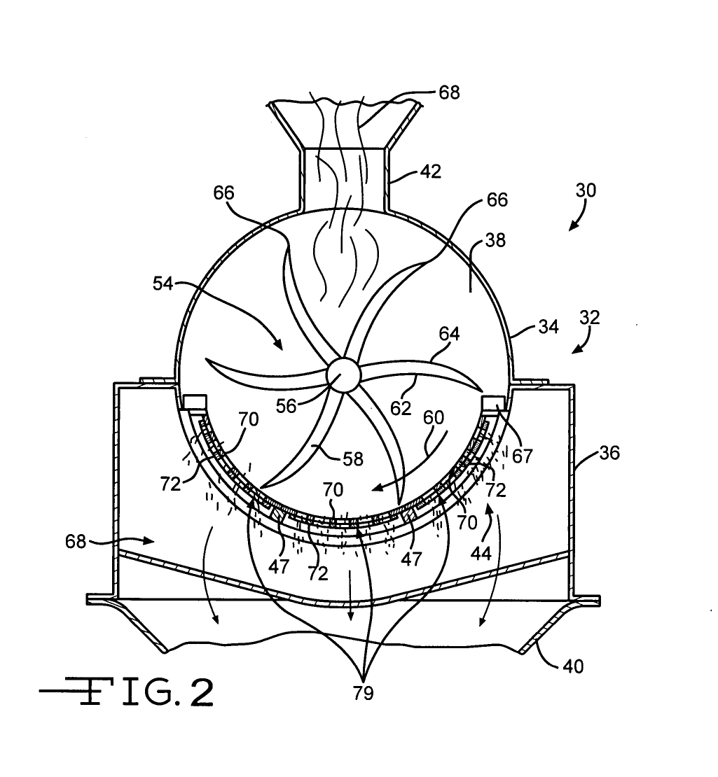

As shown in FIG. 1, a second duct 33 and entry duct 42 carry the insulation material 68 from the first processing station 29 to the rotary mill 30. The ducts 33 and 42 can be any generally hollow members that are suitable for conveying the insulation material 68. Illustrated in FIG. 2, there is shown an enlarged elevation view of the rotary mill 30 of the present invention. The rotary mill 30 includes a housing 32 that has an upper housing portion 34 and a lower arcuate screen 44 supported on a lower cage portion 36. The upper housing portion 34 is arcuate in shape and the walls of the upper housing portion 34 define an upper portion of a rotary mill chamber 38. The upper housing portion 34 is connected to the entry duct 42 through which the insulation material 68 enters the housing 32. The arcuate screen 44 defines the lower portion of the housing 32. The lower cage portion 36 can be any shape, and is shown as a generally rectangular shell that supports the arcuate screen 44 therein. The lower cage portion 36 is configured to be connected to a collection duct 40. The collection duct 40 extends from the lower cage portion 36 for receiving tufts 69 of the insulation material 68 that are created by the rotary mill 30 and transports the tufts 69 through an exit blower 46 and exit duct 48 as will be described in greater detail below.

The arcuate screen 44 is retained on the lower cage portion 36. As can be seen, the screen 44 defines the walls of the lower portion of the rotary mill chamber 38 as well. As illustrated, the screen 44 is comprised of a series of three sections. Each of the sections can be supported at their respective ends by longitudinally extending ribs 47. However, it can be appreciated that the screen 44 or screen sections can be supported by any suitable mechanism. It should also be appreciated that any number of sections can be used to form the screen 44. The structure and operation of the screen 44, in conjunction with the rotary cutter assembly 54, will be described next.

Rotatably supported within the housing 32 is the rotary cutter assembly 54. The cutter assembly 54 includes a longitudinally extending shaft 56 with a plurality of vanes 58 extending radially outwardly therefrom. The shaft 56 is connected to a drive mechanism (not shown) such as a motor, that rotates the shaft 56 in a machine direction, indicated by arrow 60. Therefore, the vanes 58 are also rotated in the machine direction 60. Although the machine direction is a clockwise direction as shown in FIG. 2, it should be appreciated that the cutter assembly 54 could be configured to operate in a counterclockwise direction with modifications to the cutter assembly 54 in a manner that would be understood by one skilled in the art. Each of the vanes 58 is connected to the shaft 56 and each vane 58 includes an arcuate leading edge 62 and an arcuate trailing edge 64 that converges with the leading edge 62 to form a contact surface 66. Each vane 58 is preferably cast from an iron alloy and is heat treated and tempered throughout the entire vane 58 to provide each vane 58 with a specified Brinell hardness. It should be appreciated that the vanes 58 can have any suitable size and shape, and can also be formed using any suitable material without departing from the scope of the invention.

After the insulation material 68 enters the rotary mill chamber 38 through the entry duct 42 the insulation material 68 is cut and compacted as the vanes 58 sweep the insulation material 68 over a cutting bar 67. In addition, the insulation material 68 is cut into tufts 69 having a major dimension or length that is on the order of about ½″ as the vanes 58 swipe the insulation material 68 against the screen 44. In particular, the contact surface 66 of each vane 58 presses the insulation material 68 against the screen 44. Since the screen 44 has a plurality of cutting edges 82 formed thereon, as can be more clearly seen in FIG. 6, the insulation material 68 will be cut as the insulation material 68 is swept across the screen 44. It should be appreciated that the major dimension or lengths of the tufts 69 of the insulation material 68 can be any size suitable for loose fill insulation. In one embodiment, the length is distributed substantially within the range of about ⅛″ to about ¾″, which means that most of the tufts 69 have a major dimension within that range. The term “tufts” includes particulate insulation material including flakes, cubes, nodules and the like suitable for being blown as loosefil insulation into insulation cavities. To prevent the insulation material 68 from becoming entangled, or from passing through the rotary mill 30 uncut, a space of about 3/16″ is maintained between the contact surfaces 66 of the vanes 58 and the screen 44. It can be appreciated that the spacing between the contact surface 66 of the vanes 58 and the screen 44 can be any suitable amount, such as a spacing within the range of about ⅛″ to about ⅜″. In addition, although only a single array of vanes 58 is shown in FIG. 2, it should be appreciated that the housing 32 extends in a longitudinal direction and thus, a plurality of vanes 58 can extend along the length of the shaft 56, which also extends in the longitudinal direction.

As stated above, the insulation material 68 is sheared to form tufts 69 having a desired length between the rotating vanes 58 and the cutting bar 67, as well as between the vanes 58 and the screen 44 to form the tufts 69. If the insulation material 68 that is not cut to the desired length or compacted to a desired density, the material might not pass through openings 80 formed through the screen 44. The insulation material 68 that does not pass through the screen 44 can be carried by the rotary cutter assembly 54 around the upper housing portion 34 of the rotary mill housing 32 until the material 68 again passes the cutting bar 67 and the screen 44 where it can be cut or compacted further into tufts 69. This working of the insulation material 68 causes the resulting tufts 69 to become more dense. The tufts 69 are then drawn through the screen 44 into the collection duct 40.

As can be seen in FIGS. 1 and 2, the collection duct 40 is fixed to the lower end of the lower cage portion 36. An exit blower 46 is attached to the collection duct 40 for creating suction within the lower cage portion 36 of the housing 32. The exit blower 46 causes the tufts 69 to be drawn through the screen 44 and discharged as tufts 69 through the exit blower 46 into an exit duct 48. The exit duct 48 carries the tufts 69 to a bagging assembly 50. If desired, the tufts 69 can be sprayed, using suitable equipment, with a dust suppressant or an anti-static agent after being cut by the rotary mill 30. The exit blower 46 can operate at various speeds as desired. Optionally, a separator 51, accompanied by a fan 52, can be positioned just before the bagging assembly 50. The fan 52 can help draw the tufts 69 through the exit duct 48 and into the bagging assembly 50. The separator 51 separates or withdraws much of the air and dust from the flow of tufts 69 in the exit duct 48.

The structure and operation of the screen 44 will be described next with respect to FIGS. 3-5. Illustrated in FIG. 3 is an exploded view of the screen 44. The screen 44 includes an inner plate 70 and an outer plate 72. The screen 44 can be retained on the lower cage portion 36 in any suitable manner. As shown, the screen 44 includes a screen frame 45 that is welded, integrally formed, or otherwise attached to the lower cage portion 36. In addition, the inner plate 70 is welded to the screen frame 45. Alternatively, the inner plate 70 could be bolted, threadably fastened, or press fit into engagement with the screen frame 45. The inner plate 70 includes a plurality of inner openings 74 formed therethrough. The inner openings 74 can have any desired shape and size. In the illustrated embodiment, each of the inner openings 74 is generally box-shaped, i.e. the shape of a rectangular prism. It can be appreciated that in a planar view, the inner openings 74 would appear to be generally rectangular. As can be seen in FIG. 3, each of the inner openings 74 is not the same size. In the illustrated embodiment, the inner openings 74 have the same width and depth as each other, but have different lengths. The purpose of such a design will be explained below. It should be appreciated that the inner openings 74 can all be the same size if it is so desired.

The outer plate 72 of the screen 44 is similarly formed with a plurality of outer openings 76 formed therethrough. Each of the outer openings 76 through the outer plate 72 is sized and positioned to so as to correspond to one of the inner openings 74 through the inner plate 70. An inner opening 74 and its corresponding outer opening 76 together form a screen opening 80, as shown in FIG. 6. The outer openings 76 through the outer plate 72 are also generally box-shaped, with a rectangular shape in a planar view. It can be appreciated that although the openings 74, 76, 80 may be referred to herein in planar geometric terms (e.g. rectangular), the openings 74, 76, 80 have a thickness corresponding to the thickness of the respective inner and outer plates 70, 72. It can also be appreciated that the openings can be polygonal, circular, oval-shaped, square, or have any other geometric configuration in the planar view. It can also be appreciated that, if it were so desired, the inner openings 74 and corresponding outer openings 76 can be different sizes.

The inner plate 70 has a length L, a width W and a thickness T. The outer plate 72 has a length l, a width w and a thickness t. Optionally, the outer plate 72 has a slightly smaller outer perimeter than the inner plate 70. In particular, the width W of the inner plate 70 is greater than the width w of the outer plate 72. As will be described below, this configuration allows the outer plate 72 room to move relative to the inner plate 70 in the machine direction (indicated in FIG. 3 by arrow 78).

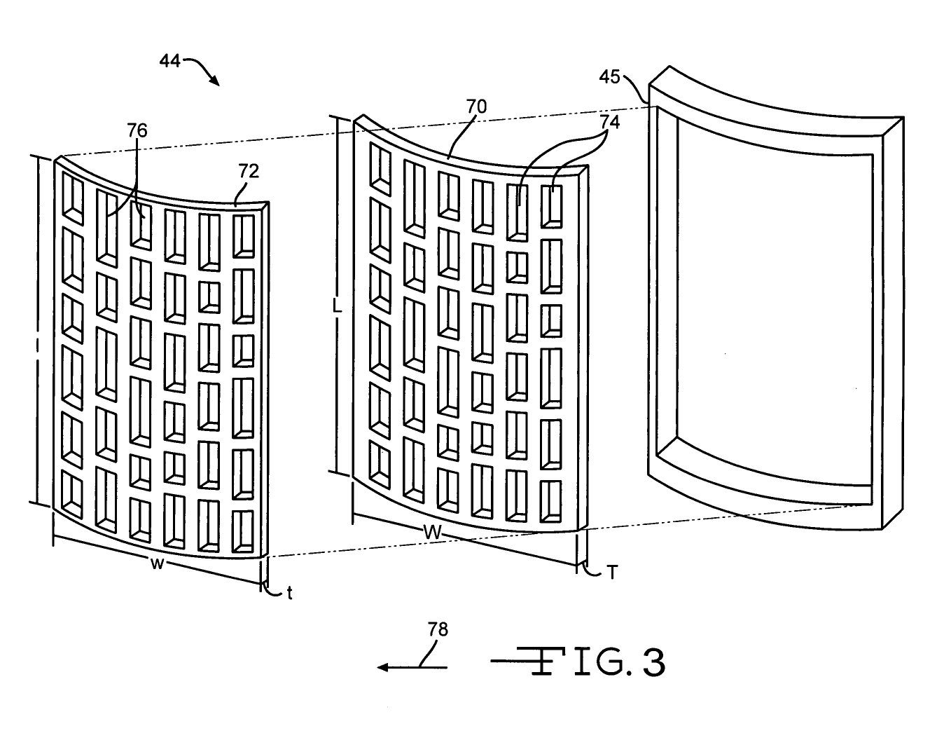

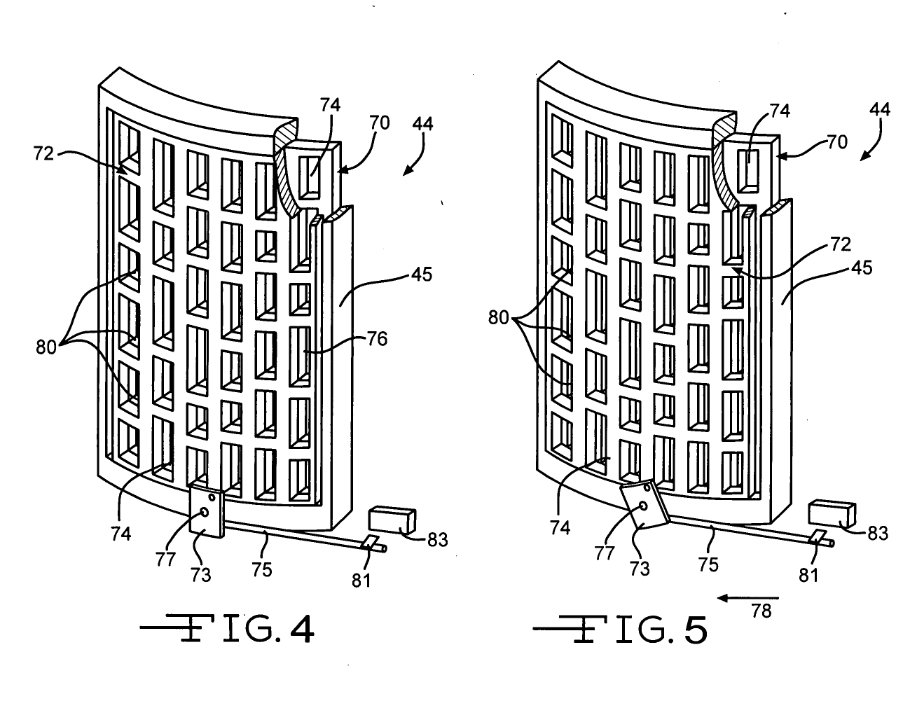

As illustrated in FIG. 4, the screen 44 is in a first configuration. In FIG. 5, the screen 44 is in a second configuration. A portion of the screen 44 has been cut away in FIGS. 4 and 5 to show the inner plate 70 more clearly. In the first position, the inner openings 74 formed through the inner plate 70 and the outer openings 76 formed through the outer plate 72 are substantially aligned thereby defining screen openings 80 having an effective opening size through the screen 44. The effective opening size controls the amount, size and density of the tufts 69 of insulation material 68 that can pass through the effective screen openings 80. In the aligned position shown in FIG. 4, the screen 44 is configured to allow the largest amount and largest size of the tufts 69 to pass through the screen 44. The effective screen opening size controls the quality of the tufts 69 of insulation material 68 in that the screen openings 80 can only allow a specific amount of material and air to pass therethrough. As the effective opening size is reduced, and in order for the same amount of tufts 69 to pass through the screen openings 80, the density of the tufts 69 can increase.

As can be seen in FIG. 5, the effective opening size of the screen openings 80 has been reduced. The reduction in size of the screen openings 80 is effected by the repositioning of the outer plate 72 relative to the inner plate 70. As shown, the outer plate 72 has been moved in the machine direction, as indicated by arrow 78, to reduce the effective opening size of the screen openings 80. The change in effective opening size of the screen openings 80 can also be seen in FIG. 6. As shown in FIG. 6, the screen 44 is viewed from inside the rotary mill 30 looking through the inner plate 70 with the outer plate 72 positioned below the inner plate 70. Although this embodiment is described as reducing the effective opening size of the screen openings 80, it should be appreciated that the openings 80 could be initially smaller, and the plates 70, 72 could be repositioned to increase the effective opening size.

The relative movement of the plates 70 and 72 is optionally controlled by the operation of a rod 75 connected with a threaded, worm-gear connection to a linkage 73. The rod 75 can be connected to the screen frame 45, or to the housing 32. The linkage 73 can be connected to the outer plate 72 such that movement of the linkage 73 causes movement of the outer plate 72. The rotation of the rod 75 moves the linkage in a generally axial direction along the rod. As the rod 75 rotates, the rod pushes or pulls the linkage 73 (depending on the desired change in effective opening size of the screen 44). The linkage 73 pivots about a pivot point 77 that is fixed on the housing 32 or screen frame 45, thereby causing the outer plate 72 to move laterally in the machine direction 78 relative to the housing 32. The housing 32 can include a scale 83 so that the movement of the outer plate 72 relative to the inner plate 70, the housing 32, or the screen frame 45 can be monitored and controlled to precisely control the size of the screen openings 80 and, therefore, control the density of the loose fill insulation 68 that passes through the screen 44. In particular, the rod 75 or linkage 73 could include indicia, shown schematically at 81, for indicating the extent of travel of the linkage 73 relative to the inner plate 70, the housing 32, or the screen frame 45. It should be appreciated that any suitable mechanism for adjusting and gauging the position of the outer plate 72 relative to the inner plate 70 can be used, such as an electronic control system.

As described above, the insulation material 68 is cut into tufts 69 as the vanes 58 sweep the insulation material 68 over the screen 44. The openings 74 of the inner plate 70 of the screen 44 include a cutting edge 82 to facilitate such cutting. The cutting edge 82 is oriented transversely to the machine direction in the illustrated embodiment. Therefore, as the vanes 58 sweep the insulation material 68 over the cutting bar 67 and the cutting edge 82, the insulation material 68 is cut into tufts 69 which pass through the inner plate 70 and the outer plate 72. If the accumulation of insulation material 68 is such that it cannot freely pass through the openings, the insulation material 68 will remain within the rotary mill chamber 38. As the insulation material 68 remains in the rotary mill chamber 38, the insulation material 68 will again pass over the cutting bar 67 and the screen 44 until the tufts 69 pass through the screen openings 80. The exit blower 46 can also act to draw the tufts 69 through the screen 44 in order to assist the movement of the tufts 69, and to prevent clogging of the screen 44. The exit blower 46 creates a suction within the lower cage portion 36 of the housing 32. As described above, the speed of operation of the exit blower 46 can be controlled to increase or decrease the amount of suction created within the lower portion of the housing 36.

Regardless of the effective opening size of the screen openings 80, the length of each cutting edge 82 remains substantially constant. Therefore, as the effective opening size changes, the length of the effective cutting edge 82 is not changed, as is shown in FIGS. 4, 5 and 6. The reason for such a design is to maintain substantially constant the size of the tufts 69 that pass through the screen 44. In particular, it is useful that the tufts 69 formed by the loose fill insulation manufacturing apparatus 10 have a substantially constant length. As described above, the term substantially constant major dimension or length means that most of the tufts 69 have sizes that fall within the distribution of about ⅛″ to about ¾″.

As can be appreciated by one skilled in the art, the longer the fibers of the insulation material 68 remain within the rotary mill chamber 38, the more the insulation material 68 is “worked”. The term “worked” is a term connoting the processing, cutting, and compacting that the material undergoes while remaining within the rotary mill chamber 38. For example, each time the vanes 58 sweep the insulation material 68 past the screen 44, the insulation material 68 is cut and compacted further into tufts 69. Compacting the insulation material 68 (both before being cut, as well as by cutting the material at least one time) can lower the K factor of the insulation by making the tufts 69 have a higher density. It is generally recognized that in colder climates, insulation having a higher density is more desirable. As described above, the lower the K factor, the lower the rate at which heat flows through the material. This translates to insulation having a greater insulative effect. Therefore, by changing the effective opening size of the screen openings 80, the K factor of the insulation that is formed can be reduced while increasing the density of the tufts 69. At the same time, the major dimension of the tufts 69 is maintained at the desired dimensions. In addition to the particular densities of the tufts 69 that are formed, it is generally recognized that the blown density of the loose fill insulation material 68 is typically between about 0.525 pounds of material per cubic foot (PCF) to about 0.700 PCF.

As is also shown in the Figures, the screen 44 has screen openings 80 that can be varied in width in the machine direction while maintaining the lengths substantially constant, thereby maintaining the effective cutting edge length substantially constant. The reason to have more than one opening size in the screen 44 is to have a predetermined percentage of the surface area of the screen 44 open while maintaining the structural rigidity of the screen 44 between the openings 80.

Additionally, as was stated above, the screen 44 can be formed having any number of sections. As illustrated, the screen 44 has three sections 79. It should be appreciated that the number of openings, the size of the openings, and the orientation of the openings on each section 79 can be the same or different from the other sections 79 comprising the screen 44. It should be appreciated that in the embodiment comprising multiple sections 79 forming the screen 44, each section 79 could include separate inner plates 70 and separate outer plates 72. Each of the outer plates 72 could also be independently movable relative to the outer plates 72 of the other sections 79. Thus, each inner plate 70 of each section 79 can be movable relative to each outer plate 72 of that section 79, and vice versa. Additionally, each outer plate 72 can be independently movable relative to each other outer plate 72. Therefore, one outer plate 72 can remain stationary while the other two plates 72 move, or all three outer plates 72 can be moved at the same time by the same amount, or at the same time by differing amounts. Similarly, each of the inner plates 70 could also be moved independently of each other. That means that each inner plate 70 could be held stationary, or moved while the other inner plates 70 are held stationary, are moved by the same amount, or are moved by a different amount.

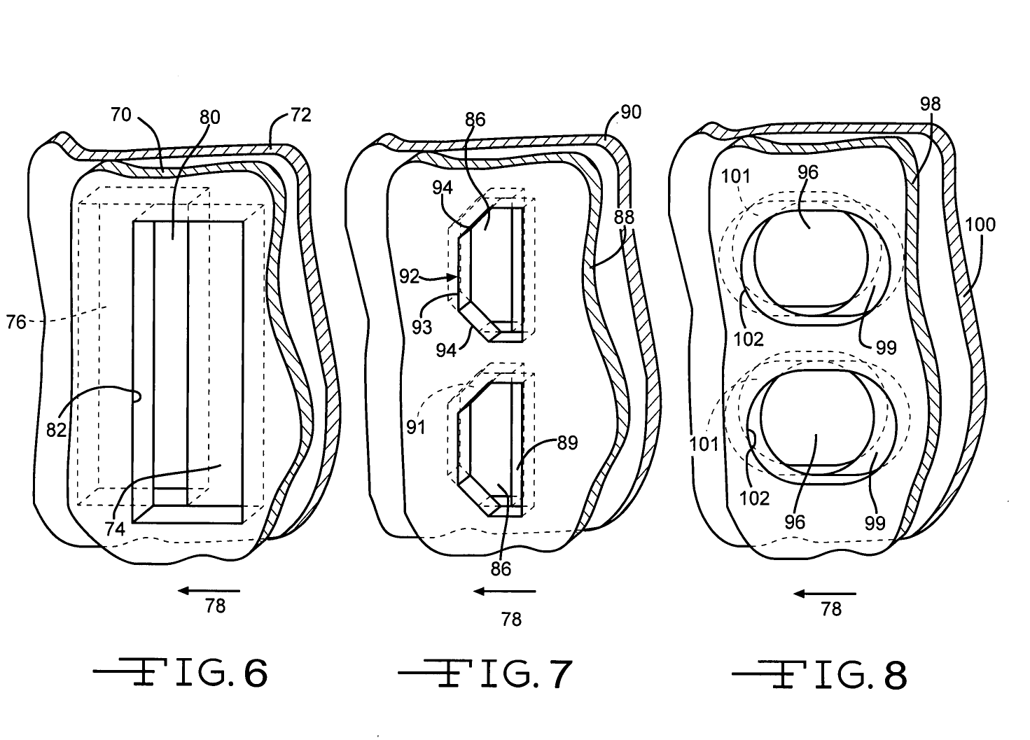

Illustrated in FIGS. 7 and 8 are alternate embodiments of the openings that can be formed through the screen 44. The views are similar to that which is shown in FIG. 6 in that the screen 44 is viewed from inside the rotary mill 30 looking through the inner plates with the outer plates positioned below the inner plates. It can be appreciated that only a portion of the screens are shown. In FIG. 7, an inner plate 88 has inner openings 89 formed therethrough. An outer plate 90 has outer openings 91 formed therethrough. The inner openings 89 and outer openings 91 cooperate to form screen openings 86. The screen openings 86 have a polygonal shape. The shape of these openings 86 can be polygonal in three dimensions. The mathematical term for such a structure is a polyhedron. The effective cutting edge 92 of the openings 86 has a first portion 93 that is substantially transverse to the machine direction 78. The effective cutting edge 92 also has second portions 94 that are angled at an acute angle relative to the machine direction 78. In FIG. 8, an inner plate 98 has inner openings 99 formed therethrough. An outer plate 100 has outer openings 101 formed therethrough. The inner openings 99 and outer openings 101 cooperate to form screen openings 96. The screen openings 96 have the shape of an elongated circle. The effective cutting edge 102 is substantially arcuate in shape. As with the embodiments described above, even though the effective opening size is changed, the lengths of the effective cutting edges 92, 102 of the embodiments shown in FIGS. 7 and 8 are maintained substantially constant.

It can be appreciated that the openings formed through a screen of the rotary mill 30 can have any size, shape, and orientation. Also, the openings through any of the inner plates described above could be larger, smaller, or the same size as, the openings through any of the corresponding outer plates. In addition, it should be appreciated that any of the inner plates described above could be moved relative to a fixed outer plate, if it were so desired. Alternatively, both plates could be movable relative to each other, and relative to the housing 32 of the rotary mill 30. It should also be appreciated that the inner plate and outer plate can be formed from different materials if it is so desired. For example, the inner plate 70 could be made from stainless steel having a hard wearing cutting edge and the outer plate could be made from plate steel. Having plates 70, 72 formed from different materials would be beneficial because it would use the more costly material only where it is needed.

The above description of the preferred embodiments of the methods and apparatus of this invention is intended to be illustrative in nature and is not intended to be limiting upon the scope and content of the following claims. In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A rotary mill configured to cut fibrous insulation material into tufts of loosefil insulation comprising:
a housing having a rotary cutter assembly mounted therein, the rotary cutter assembly includes a plurality of radially outwardly extending vanes that extend to the housing and are configured to sweep fibrous insulation material along the housing in a machine direction;
a screen positioned in the housing, the screen having a plurality of screen openings through which the fibrous insulation material can be passed to form tufts of loosefil insulation, each screen opening having an effective opening size, wherein the screen comprises an inner plate having a plurality of inner openings formed therethrough, and an outer plate having a plurality of outer openings formed therethrough;
wherein the inner openings correspond with the outer openings to define the screen openings, and the screen openings have effective cutting edges oriented transversely to the machine direction;
wherein the inner and outer plates are mounted for movement relative to each other such that the effective opening size of the screen openings in the screen can be changed; and
wherein the length of the effective cutting edges of the screen openings is kept substantially constant regardless of changes in the size of the screen openings.

2. The rotary mill defined in claim 1 wherein the inner openings through the inner plate have the same size as corresponding outer openings through the outer plate.

3. The rotary mill defined in claim 1 wherein the inner openings through the inner plate and corresponding outer openings through the outer plate have different sizes.

4. The rotary mill defined in claim 1 wherein the outer plate is movable in the machine direction to reduce the size of the effective openings of the screen.

5. The rotary mill defined in claim 1 wherein the inner plate is movable opposite the machine direction to reduce the size of the effective openings of the screen.

6. The rotary mill defined in claim 1 wherein the inner openings through the inner plate are of more than one opening size.

7. The rotary mill defined in claim 6 wherein the outer openings through the outer plate are of more than one opening size.

8. The rotary mill defined in claim 1 wherein the rotary mill includes a plurality of inner plates and a corresponding plurality of outer plates;
and further includes a mechanism for sliding each of the outer plates relative to each of the inner plates such that each outer plate is independently movable relative to each other outer plate.

9. The rotary mill defined in claim 1 wherein the inner openings through the inner plate have a shape of a polygon.

10. The rotary mill defined in claim 1 wherein the inner openings through the inner plate are generally rectangular.

11. The rotary mill defined in claim 1 wherein the openings inner through the inner plate have an arcuate cutting edge.

12. The rotary mill defined in claim 1 further comprising a mechanism for sliding the outer plate relative to the inner plate including a rod connected to a linkage, the linkage further connected to the outer plate such that movement of the rod causes the linkage to pivot, thereby causing the outer plate to slide relative to the inner plate.

13. The rotary mill defined in claim 12 wherein the housing includes a scale and the rod includes indicia for indicating travel of the rod relative to the scale, thereby indicating an amount of movement of the outer plate relative to the inner plate.

14. A rotary mill configured to cut fibrous insulation material into tufts of fibrous insulation, the mill comprising:
a housing having a rotary cutter assembly mounted therein, the rotary cutter assembly including a plurality of radially outwardly extending vanes that extend to the housing and are configured to sweep fibrous insulation material along the housing in a machine direction;
a screen positioned in the housing, the screen having a plurality of rectangular screen openings through which the fibrous insulation material can be passed to form tufts of loosefil insulation, each screen opening having an effective opening size, wherein the screen comprises an inner plate having a plurality of rectangular inner openings formed therethrough, and an outer plate having a plurality of outer openings formed therethrough;
wherein the inner openings correspond with the outer openings to define the screen openings, and the screen openings have an effective cutting edge oriented transversely to the machine direction;
wherein the inner and outer plates are mounted for movement relative to each other such that the effective opening size of the screen openings in the screen can be changed; and
wherein the length of the effective cutting edges of the screen openings is kept substantially constant regardless of any change in the size of the screen openings, and the shape of the screen openings is kept substantially rectangular.

15. The rotary mill defined in claim 14 wherein the outer openings formed through the outer plate are rectangular.

16. The rotary mill defined in claim 14 wherein the inner openings through the inner plate have the same size as corresponding outer openings through the outer plate.

17. The rotary mill defined in claim 14 wherein the inner openings through the inner plate and corresponding outer openings through the outer plate have different sizes.

18. The rotary mill defined in claim 14 wherein the outer plate is movable in the machine direction to reduce the size of the effective openings of the screen.

19. The rotary mill defined in claim 14 wherein the rotary mill includes a plurality of inner plates and a corresponding plurality of outer plates;
and further includes a mechanism for sliding each of the outer plates relative to each of the inner plates such that each outer plate is independently movable relative to each other outer plate.

20. A method of forming tufts of loosefil insulation comprising:
providing a rotary cutter assembly having a housing, the rotary cutter assembly having a plurality of rotating vanes that extend to the housing and are configured to sweep along the housing in a machine direction;
providing a screen within the rotary cutter assembly, the screen having an inner and outer plate, the inner plate having inner openings and the outer plate having outer openings corresponding to the inner openings, the inner and the outer openings defining screen openings having an effective opening size, the screen openings having an effective cutting edge oriented transversely to the machine direction, the inner and outer plates being movable relative to each other to change the effective opening size of the screen openings;
introducing fibrous insulation material into the rotary cutter assembly; and
cutting the fibrous insulation material into tufts of loosefil insulation by rotating the cutter assembly to sweep the fibrous insulation material against the screen;
modifying the density of the tufts of loosefil insulation while maintaining the tufts of loosefil insulation at a substantially constant size by moving the inner and outer plates relative to each other to change the effective opening size while maintaining the length of the effective cutting edges substantially constant.
